(19) United States
(12) Patent Application Publication
(10) Pub. No.: US 2026/0360985 A1
(43) Pub. Date: Nov. 12, 2026

(54) HYBRID ANTENNA FOR CHASSIS WITH METALLIC EDGES

(71) Applicant: DELL PRODUCTS L.P., Round Rock, TX (US)

(72) Inventors: Ying Zu, Round Rock, TX (US); Ching Wei Chang, Round Rock, TX (US); Changsoo Kim, Cedar Park, TX (US); Yun-Tsan Lee, Hsinchu City (TW)

(21) Appl. No.: 19/199,680

(22) Filed: May 6, 2025

(51) Int. Cl. H01Q 9/04; H01Q 1/22

(52) U.S. Cl. CPC H01Q 9/0421; H01Q 1/2291

(57) ABSTRACT

A hybrid antenna within a metal-edged chassis of an information handling system includes a planar inverted-F antenna (PIFA). The hybrid antenna includes a metallic frame surrounding a radio-frequency (RF) antenna window formed in the metal-edged chassis. A gap is formed between the PIFA and the metallic frame. The PIFA, the metallic frame, and the gap are configured to operate as a slot antenna in response to electric current induced by excitation of the PIFA and metallic frame with RF energy.

### FIELD OF THE DISCLOSURE

The present disclosure generally relates to information handling systems, and more particularly relates to antennas and related apparatuses in information handling systems with wireless communication capabilities.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

A hybrid antenna within a metal-edged chassis of an information handling system includes a planar inverted-F antenna (PIFA). The hybrid antenna includes a metallic frame surrounding a radio-frequency (RF) antenna window formed in the metal-edged chassis. A gap is formed between the PIFA and the metallic frame. The PIFA, the metallic frame, and the gap are configured to operate as a slot antenna in response to electric current induced by excitation of the PIFA and metallic frame with RF energy.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a partially exploded view of a portion of a metal-edged chassis of an information handling system according to at least one embodiment of the present disclosure;

FIG. 2 is top view of a hybrid antenna housed within a metal-edged chassis of an information handling system according to at least one embodiment of the present disclosure;

FIG. 3 illustrates an electric current distribution induced in a slot antenna formed by a planar inverted-F antenna (PIFA) pattern and a metal frame above the PIFA pattern when the slot antenna is excited by radiofrequency (RF) energy according to at least one embodiment of the present disclosure;

FIG. 4 illustrates a graph of the return loss of a hybrid antenna operating at various frequencies within a 600 MHz to 6 GHz band of frequencies according to at least one embodiment of the present disclosure;

FIG. 5 is a flow diagram of a method creating a hybrid antenna for a metal-edged chassis according to at least one embodiment of the present disclosure; and

FIG. 6 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

In addition, many types of information handling systems also include communications circuitry such as a transceiver and one or more antennas for wirelessly receiving and transmitting data. The chassis of most modern laptops, for example, includes a wireless transceiver capable of connecting a laptop to Wi-Fi networks. Providing a laptop, tablet, or other type of information handling systems with wireless capabilities, however, may present several challenges, especially given the trend towards housing such systems in ever-thinner, more streamlined chassis. Increasingly, the antennas are moved from the chassis lid into the chassis base to permit a display screen embedded in the chassis lid to fully extend to the edges of the lid, thereby achieving a bezel-less display.

The edges of the chassis base, in turn, are increasingly formed by a metallic material such as aluminum, magnesium, or a metal alloy to provide strength and durability to the thin chassis. To further enhance the aesthetic appeal of the chassis, the metal edges of the chassis base are devoid of any non-metallic material (e.g., plastic or other dielectric) and are entirely free of any apertures to thus create a uniformly smooth metal surface. Without any apertures or non-metallic insets, the surrounding metal edges are likely to significantly degrade the antenna's signaling capabilities. Moreover, regions adjacent to the edges tend to be thin and other regions are typically occupied by components (e.g., batteries, printed circuit board (PCB), keyboard) that preclude placement of the antenna away from the metal edges of the chassis. These challenges add to the already significant challenge of providing an antenna capable of handling wireless signals within the 600 MHz to 6 GHz range for communication with a wireless wide-area network (WWAN).

In accordance with embodiments of the present disclosure, a hybrid antenna is provided that overcomes these and other challenges. The hybrid antenna is capable of enabling multi-resonate modes over the frequency spectrum of 600 MHz to 6 GHz, operating within a metal-edged chassis. The hybrid antenna is a combination of slot antenna and planar inverted-F antenna (PIFA). The hybrid antenna is configured to provide low-band frequencies primarily with the slot antenna, which is capable of deep resonance at low-band frequencies, and to provide mid-band and high-band frequencies with the slot and PIFA antennas operating cooperatively. Accordingly, the hybrid antenna is capable of providing wide bandwidth communications capabilities for an information handling systems housed in metal-edged chassis.

The form of the hybrid antenna, moreover, is such that it operates effectively and efficiently within the narrow confines of a streamlined, metal-edged chassis. The hybrid antenna may be positioned within the metal-edged chassis relatively near to a metal edge of the chassis. In certain embodiments, the hybrid antenna is configured for efficient sizing within the chassis by imprinting portions of the hybrid antenna on a speaker box using laser direct structuring, with the speaker chamber serving as an antenna carrier.

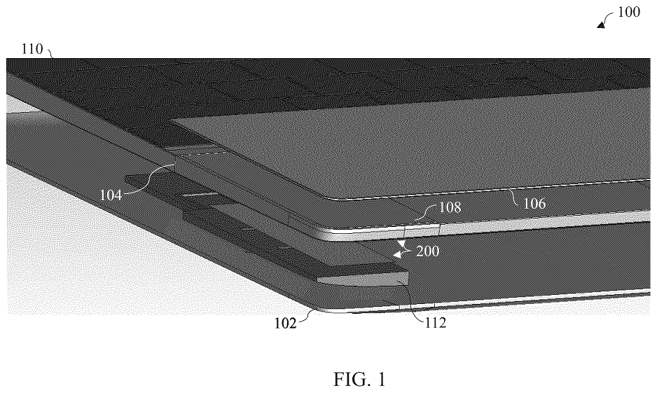

FIG. 1 is a partially exploded view of a portion of a metal-edged chassis 100 of an information handling system according to an embodiment of the present disclosure. Metal-edged chassis 100 houses the working components of the information handling system, which may be a laptop, tablet computer, or other portable information handling system. Metal-edged chassis 100 includes a base formed by D-case 102 over which extends C-cover 104. D-case 102 and C-cover 104 are formed of a metal or metal alloy. A lid (not shown) may pivotally connect to the base. Glass inlay 106 may extend over antenna window 108 formed in the surface of C-cover 104 below keyboard 110. Antenna window 108 extends over an interior portion of D-case 102 and is made of a material such as plastic or other dielectric material that is radio-frequency (RF) transparent. An additional, RF-transparent antenna window (not shown) may be formed in a bottom portion of D-case 102. Each side of D-case 102 may be formed of a metal or metal alloy.

In various embodiments, each metallic edge of D-case 102 of metal-edged chassis 100 may be entirely or at least substantially devoid of any openings. Each metallic edge of D-case 102 likewise may be entirely or at least substantially free of non-metallic insets, thus providing a uniform metal circumference. Within the interior portion of D-case 102 is speaker box 112. A hybrid antenna 200, in certain embodiments, is formed partly on speaker box 112 and partly by metal edges framing antenna window 108 inset in C-cover 104.

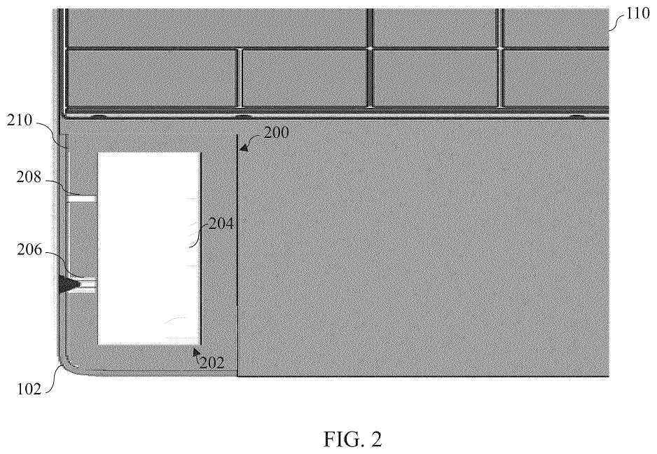

FIG. 2 is top view of hybrid antenna 200 within metal-edged chassis 100. Hybrid antenna 200 includes planar inverted-F antenna (PIFA) 202, which in accordance with certain embodiments is illustratively formed on speaker box 112 situated on an interior surface of D-case 102. PIFA 202 is positioned underneath antenna window 108 made of RF-transparent material and inset in C-cover 104 made of metal. In certain embodiments, PIFA 202 may be formed of metal traces imprinted on speaker box 112, the metal traces imprinted by the laser direct structuring. PIFA 202 is made up of radiating element 204, feed structure 206 extending from the radiating element, and shorting pin 208 also extending from the radiating element. Operatively, radiating element 204 is capable of emitting and receiving electromagnetic waves and is energized via feed structure 206, which may connect to a transceiver or transmitter (not shown) housed within D-case 102.

Hybrid antenna 200 further includes metallic frame 210. Metallic frame 210, in various embodiments, is formed by the metal edges of C-cover 104 surrounding antenna window 108 made of RF-transparent material inset in the metallic C-cover. A gap is formed between radiating element 204 and metallic frame 210. The gap is formed by the space between radiating element 204 and metallic frame 210 surrounding antenna window 108, which is positioned above PIFA 202 over the radiating element. PIFA 202, metallic frame 210, and the gap between the two are configured to operate as slot antenna. Operating as a slot antenna, the gap radiates electromagnetic (EM) waves in response to electric current induced in PIFA 202 and metallic frame 210 by excitation of the PIFA and metallic frame by RF energy. RF energy may be fed to PIFA 202 and metallic frame 210 by the same transceiver or transmitter that energizes PIFA 202, the transceiver or transmitter housed within D-case 102 beneath C-cover 104.

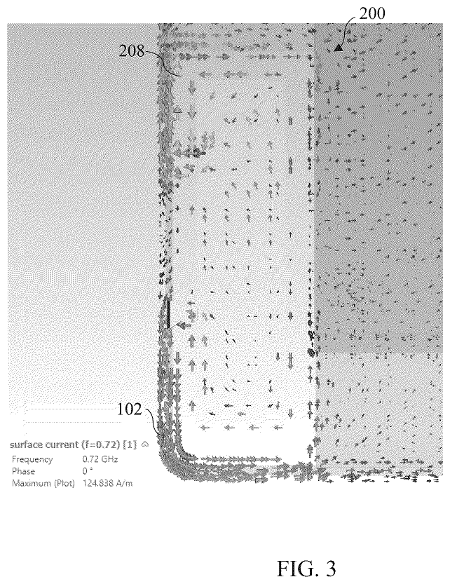

FIG. 3 illustrates the electric current distribution induced in metallic frame 210 and radiating element 204 when each is excited by RF energy. Acting as a slot antenna in response to the electric current, hybrid antenna 200 is capable of creating deep resonance at low frequencies of the 600 MHz to 6 GHz band of frequencies. PIFA 202, metallic frame 210, and the gap formed between the PIFA and metallic frame, acting as a slot antenna, are capable of operating cooperatively to provide wide bandwidth coverage in response to excitation of hybrid antenna 200 by RF energy. As configured, hybrid antenna 200 is capable of supporting WWAN and/or other wireless communications between the information handling system and an external device. The wireless signal bandwidth may be approximately 600 megahertz (MHz) to approximately 6 gigahertz (GHz). Changing the antenna pattern of PIFA 202, changes the operational parameters of the slot antenna formed by the PIFA, metallic frame 210, and the gap between the PIFA and metallic frame.

Electromagnetic radiation in the RF range may be transmitted and received by hybrid antenna 200 via RF-transparent antenna window 108 inset in metallic C-cover 104 and via another antenna window formed in a bottom portion of the D-case 102 of metal-edged chassis 100.

One of the advantages of the arrangement of hybrid antenna 200 is the use of the frame that surrounds an antenna window coupled with a separately formed PIFA to create an additional antenna, namely a slot antenna. With a metallic C-cover, the RF-transparent antenna window is a necessary adjunct. Hybrid antenna 200 leverages an existing PIFA, the metal surrounding the RF-transparent window, and gap therebetween to create an additional slot antenna without the necessity of additional antenna components.

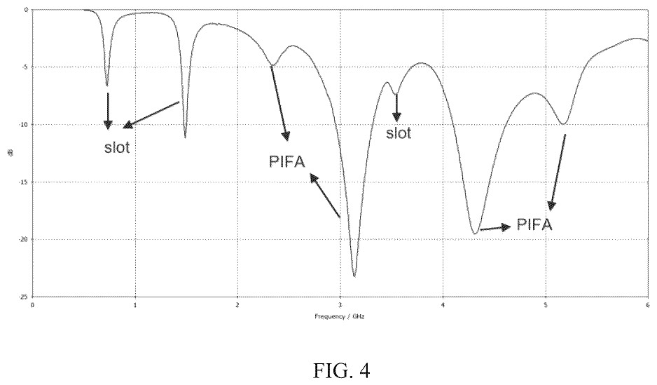

FIG. 4 is a graph 400 of the return loss of hybrid antenna 200 of FIGS. 1 and 2 operating at various frequencies within the 600 MHz to 6 GHz band of frequencies, it being understood that the larger the negative decibels the less power that is lost due to impedance mismatch in a transmission path of the hybrid antenna. As shown in graph 400, PIFA 202 of FIG. 2 and the gap between the PIFA and metallic frame 210 of FIG. 2, operating as a slot antenna, are capable of operating cooperatively in a hybrid mode at mid and high bands of the signal bandwidth. Metallic frame 210, PIFA 202, and the gap between the metallic frame and PIFA, operating solely as a slot antenna, is capable of operating at the low band of the signal bandwidth.

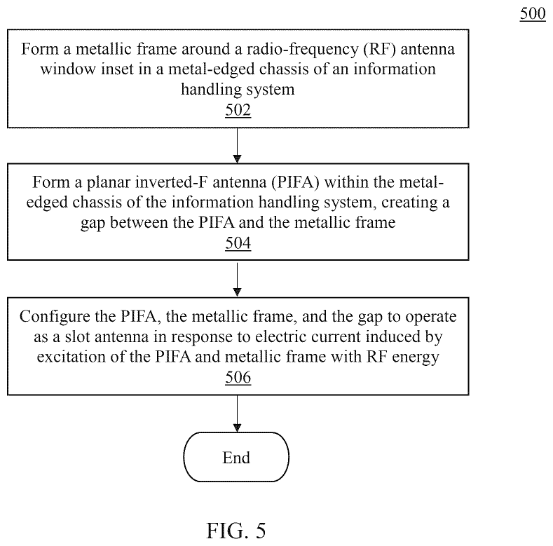

FIG. 5 is a flow diagram of a method 500 for creating a hybrid antenna for a metal-edged chassis according to at least one embodiment of the present disclosure. It will be readily appreciated that not every method step set forth in this flow diagram is always necessary, and that certain steps of the method may be combined, performed simultaneously, in a different order, or perhaps omitted, without varying from the scope of the disclosure. Method 500 may be performed to create a hybrid antenna such as that described with reference to FIGS. 1-4.

At step 502, method 500 includes forming a metallic frame around a radio-frequency (RF) antenna window inset in a metal-edged chassis of an information handling system. In various embodiments, each edge of the metal-edged chassis may be formed of a solid metal substantially devoid of openings and non-metallic insets. At step 504, method 500 includes forming a planar inverted-F antenna (PIFA) within the metal-edged chassis of an information handling system, creating a gap between the PIFA and the metallic frame. The metallic frame, in certain embodiments, may be formed by metal edges surrounding an RF-transparent antenna window inset in a C-cover of the metal-edged chassis. As configured, with the metallic frame above the PIFA, a gap is formed between the metallic frame and the PIFA. At step 506, method 500 includes configuring the PIFA, the metallic frame, and gap between the PIFA and metallic frame to operate as a slot antenna in response to electric current induced by excitation of the metallic frame and the PIFA with radio frequency (RF) energy. In response to the induced electric current, the gap radiates EM waves.

Jointly, the PIFA and metallic frame form a hybrid antenna configured to support WWAN and/or other wireless communications between the information handling system and an external device. In particular, hybrid antenna may be configured to provide a wireless signal bandwidth of approximately 600 megahertz (MHz) to approximately 6 gigahertz (GHz). Electromagnetic radiation in the RF range may be transmitted and received by the hybrid antenna via the RF-transparent antenna window inset in the C-cover and via an antenna window formed in a bottom portion of the D-case of the metal-edged chassis.

In certain embodiments, the PIFA may be formed on a speaker box within the D-case of the metal-edged chassis beneath the RF-transparent antenna inset in the C-cover. The PIFA, in some embodiments, may be formed on the speaker box by imprinting metal traces on the speaker box by laser direct structuring.

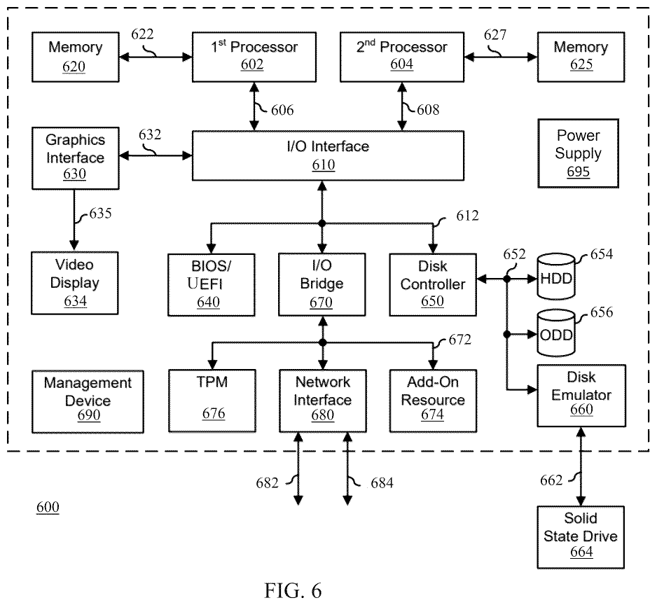

FIG. 6 shows a generalized embodiment of an information handling system 600 according to an embodiment of the present disclosure. Information handling system 600 may be housed within a metal-edged chassis that is substantially similar to that of FIG. 1 and that houses a hybrid antenna for supporting wireless communications of the information handling system. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 600 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 600 can include processing resources for executing machine-executable code, such as a central processing unit (CPU), a programmable logic array (PLA), an embedded device such as a System-on-a-Chip (SoC), or other control logic hardware. Information handling system 600 can also include one or more computer-readable mediums for storing machine-executable code, such as software or data. Additional components of information handling system 600 can include one or more storage devices that can store machine-executable code, one or more communications ports for communicating with external devices, and various input and output (I/O) devices, such as a keyboard, a mouse, and a video display. Information handling system 600 can also include one or more buses operable to transmit information between the various hardware components.

Information handling system 600 can include devices or modules that embody one or more of the devices or modules described below and operates to perform one or more of the methods described below. Information handling system 600 includes a processors 602 and 604, an input/output (I/O) interface 610, memories 620 and 625, a graphics interface 630, a basic input and output system/universal extensible firmware interface (BIOS/UEFI) module 640, a disk controller 650, a hard disk drive (HDD) 654, an optical disk drive (ODD) 656, a disk emulator 660 connected to an external solid state drive (SSD) 664, an I/O bridge 670, one or more add-on resources 674, a trusted platform module (TPM) 676, a network interface 680, a management device 690, and a power supply 695. Processors 602 and 604, I/O interface 610, memory 620, graphics interface 630, BIOS/UEFI module 640, disk controller 650, HDD 654, ODD 656, disk emulator 660, SSD 664, I/O bridge 670, add-on resources 674, TPM 676, and network interface 680 operate together to provide a host environment of information handling system 600 that operates to provide the data processing functionality of the information handling system. The host environment operates to execute machine-executable code, including platform BIOS/UEFI code, device firmware, operating system code, applications, programs, and the like, to perform the data processing tasks associated with information handling system 600.

In the host environment, processor 602 is connected to I/O interface 610 via processor interface 606, and processor 604 is connected to the I/O interface via processor interface 608. Memory 620 is connected to processor 602 via a memory interface 622. Memory 625 is connected to processor 604 via a memory interface 627. Graphics interface 630 is connected to I/O interface 610 via a graphics interface 632 and provides a video display output 636 to a video display 634. In a particular embodiment, information handling system 600 includes separate memories that are dedicated to each of processors 602 and 604 via separate memory interfaces. An example of memories 620 and 630 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 640, disk controller 650, and I/O bridge 670 are connected to I/O interface 610 via an I/O channel 612. An example of I/O channel 612 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 610 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 640 includes BIOS/UEFI code operable to detect resources within information handling system 600, to provide drivers for the resources, initialize the resources, and access the resources. BIOS/UEFI module 640 includes code that operates to detect resources within information handling system 600, to provide drivers for the resources, to initialize the resources, and to access the resources.

Disk controller 650 includes a disk interface 652 that connects the disk controller to HDD 654, to ODD 656, and to disk emulator 660. An example of disk interface 652 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 660 permits SSD 664 to be connected to information handling system 600 via an external interface 662. An example of external interface 662 includes a USB interface, an IEEE 4394 (Firewire) interface, a proprietary interface, or a combination thereof. Alternatively, solid-state drive 664 can be disposed within information handling system 600.

I/O bridge 670 includes a peripheral interface 672 that connects the I/O bridge to add-on resource 674, to TPM 676, and to network interface 680. Peripheral interface 672 can be the same type of interface as I/O channel 612 or can be a different type of interface. As such, I/O bridge 670 extends the capacity of I/O channel 612 when peripheral interface 672 and the I/O channel are of the same type, and the I/O bridge translates information from a format suitable to the I/O channel to a format suitable to the peripheral channel 672 when they are of a different type. Add-on resource 674 can include a data storage system, an additional graphics interface, a network interface card (NIC), a sound/video processing card, another add-on resource, or a combination thereof. Add-on resource 674 can be on a main circuit board, on separate circuit board or add-in card disposed within information handling system 600, a device that is external to the information handling system, or a combination thereof.

Network interface 680 represents a NIC disposed within information handling system 600, on a main circuit board of the information handling system, integrated onto another component such as I/O interface 610, in another suitable location, or a combination thereof. Network interface device 680 includes network channels 682 and 684 that provide interfaces to devices that are external to information handling system 600. In a particular embodiment, network channels 682 and 684 are of a different type than peripheral channel 672 and network interface 680 translates information from a format suitable to the peripheral channel to a format suitable to external devices. An example of network channels 682 and 684 includes InfiniBand channels, Fibre Channel channels, Gigabit Ethernet channels, proprietary channel architectures, or a combination thereof. Network channels 682 and 684 can be connected to external network resources (not illustrated). The network resource can include another information handling system, a data storage system, another network, a grid management system, another suitable resource, or a combination thereof.

Management device 690 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 600. In particular, management device 690 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 600, such as system cooling fans and power supplies. Management device 690 can include a network connection to an external management system, and the management device can communicate with the management system to report status information for information handling system 600, to receive BIOS/UEFI or system firmware updates, or to perform other task for managing and controlling the operation of information handling system 600.

Management device 690 can operate off a separate power plane from the components of the host environment so that the management device receives power to manage information handling system 600 when the information handling system is otherwise shut down. An example of management device 690 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 690 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

That which is claimed is:

1. A hybrid antenna within a metal-edged chassis of an information handling system, the hybrid antenna comprising:
a planar inverted-F antenna (PIFA); and
a metallic frame surrounding a radio-frequency (RF) antenna window formed in the metal-edged chassis,
wherein a gap is formed between the PIFA and the metallic frame, and
wherein the PIFA, the metallic frame, and the gap are configured to operate as a slot antenna in response to electric current induced by excitation of the PIFA and metallic frame with RF energy.

2. The hybrid antenna of claim 1, wherein each edge of the metal-edged chassis is formed of a solid metal substantially devoid of openings and non-metallic insets.

3. The hybrid antenna of claim 1, wherein the PIFA is formed on a speaker box within the metal-edged chassis.

4. The hybrid antenna of claim 3, wherein the PIFA comprises metal traces imprinted on the speaker box by laser direct structuring.

5. The hybrid antenna of claim 1, wherein the hybrid antenna is configured to support wireless wide area network (WWAN) communications between the information handling system and an external device.

6. The hybrid antenna of claim 1, wherein the hybrid antenna is configured to provide a wireless signal bandwidth of approximately 600 megahertz (MHz) to approximately 6 gigahertz (GHz).

7. The hybrid antenna of claim 6, wherein the PIFA and slot antenna are configured to operate cooperatively in mid and high bands of the wireless signal bandwidth and the slot antenna is configured to operate at a lower band of the wireless signal bandwidth.

8. An information handling system, comprising:
a metal-edged chassis;
one or more processing units housed within the metal-edged chassis;
a computer-readable storage medium coupled with the one or more processing units; and
a hybrid antenna, wherein the hybrid antenna includes
a planar inverted-F antenna (PIFA); and
a metallic frame surrounding a radio-frequency (RF) antenna window formed in the metal-edged chassis,
wherein a gap is formed between the PIFA and the metallic frame, and
wherein the PIFA, the metallic frame, and the gap are configured to operate as a slot antenna in response to electric current induced by excitation of the PIFA and metallic frame with RF energy.

9. The information handling system of claim 8, wherein each edge of the metal-edged chassis is formed of a solid metal substantially devoid of openings and non-metallic insets.

10. The information handling system of claim 8, wherein the PIFA is formed on a speaker box within the metal-edged chassis.

11. The information handling system of claim 10, wherein the PIFA comprises metal traces imprinted on the speaker box by laser direct structuring.

12. The information handling system of claim 8, wherein the hybrid antenna is configured to support wireless wide area network (WWAN) communications between the information handling system and an external device.

13. The information handling system of claim 8, wherein the hybrid antenna is configured to provide a wireless signal bandwidth of approximately 600 megahertz (MHz) to approximately 6 gigahertz (GHz).

14. The information handling system of claim 13, wherein the PIFA and slot antenna are configured to operate cooperatively in mid and high bands of the wireless signal bandwidth and the slot antenna is configured to operate at a lower band of the wireless signal bandwidth.

15. A method, comprising:
forming a planar inverted-F antenna (PIFA) within a metal-edged chassis of an information handling system;
forming a metallic frame around a radio-frequency (RF) antenna window inset in the metal-edged chassis, wherein a gap is formed between the PIFA and the metallic frame; and
configuring the PIFA, the metallic frame, and the gap to operate as a slot antenna in response to electric current induced by excitation of the PIFA and metallic frame with RF energy.

16. The method of claim 15, wherein each edge of the metal-edged chassis is formed of a solid metal substantially devoid of openings and non-metallic insets.

17. The method of claim 15, wherein forming the PIFA comprises:
forming the PIFA on a speaker box within the metal-edged chassis.

18. The method of claim 17, wherein the forming the PIFA comprises:
imprinting metal traces on the speaker box by laser direct structuring.

19. The method of claim 15, wherein the PIFA and metallic frame form a hybrid antenna configured to support wireless wide area network (WWAN) communications between the information handling system and an external device.

20. The hybrid antenna of claim 19, wherein the hybrid antenna is configured to provide a wireless signal bandwidth of approximately 600 megahertz (MHz) to approximately 6 gigahertz (GHz).
